(19) United States
(12) Patent Application Publication
(10) Pub. No.: US 2015/0279525 A1
(43) Pub. Date: Oct. 1, 2015

(54) ELECTOMAGNETICALLY ACTIVE ELEMENTS, ALLOYS, COMPOUNDS AND COMPOSITIONS FOR FIREARMS FABRICATED BY ADDITIVE MANUFACTURING

(71) Applicants: Paul Reep, Ojai, CA (US); Richard Weddle, Ojai, CA (US); Kabir Sagoo, Ojai, CA (US)

(72) Inventors: Paul Reep, Ojai, CA (US); Richard Weddle, Ojai, CA (US); Kabir Sagoo, Ojai, CA (US)

(21) Appl. No.: 14/662,110

(22) Filed: Mar. 18, 2015

Related U.S. Application Data
(60) Provisional application No. 61/971,501, filed on Mar. 27, 2014.

(51) Int. Cl. H01F 1/01; G01V 3/10; G01N 27/72; B29C 67/00; F41A 3/66

(52) U.S. Cl. CPC H01F 1/01; B29C 67/0055; F41A 3/66; G01N 27/72; G01V 3/10; B29K 2101/12

(57) ABSTRACT

Chemical or physical markers (i.e., tags) can be embedded in a host resin-based, polymer or thermoplastic matrix used as feedstock for additive manufacturing. These tags can comprise detectable levels of magnetic, electromagnetic, ferromagnetic and other metal alloy materials within the metallic feedstock materials used to create objects via additive manufacturing. Feedstock including tags can be used to manufacture firearms or other objects. The properties of such tags may be used to improve, enhance, or degrade-by-design the properties of the host material. Accordingly, the use of tags can provide traceability, authentication, and other characteristics to a firearm that enable detection and communication between the firearm and sensors.

### CROSS-REFERENCE TO RELATED APPLICATIONS

This application claims the benefit of U.S. Provisional Patent Application No. 61/971,501 which was filed on Mar. 27, 2014.

### BACKGROUND

Additive manufacturing (AM) refers to the industrial technologies for ‘printing’ or laying down objects layer-by-layer. This type of manufacturing is colloquially referred to as ‘3D printing.’ Additive manufacturing relies on a computer and 3D modeling software to produce a parsed and layered model of the object to be ‘printed’ and may include not only layer by layer but also a ‘particle by particle’ additive processes. Data is input into the additive manufacturing printer using specific software to lay down or add successive layers of liquid, powder, particles, nano-blocks, sheet materials, or other feedstock, in a layer-upon-layer fashion that fabricates the 3D object. The feedstock for additive manufacturing systems may be dispensed by several methods such as extrusion deposition, wire deposition, granular deposition, powder-bed, inkjet-head deposition, lamination, and photopolymerization and may include particle by particle placement technology. The terms ‘feedstock’ or ‘materials’ apply to powders, viscous liquids, polymeric materials, metals, wires, ceramics, adhesives, and other materials used as raw materials for AM.

Although there may be policies which restrict or forbid the manufacturing of 3D printed firearms, it is likely only a matter of time until these weapons are made in homes on simple equipment, available to the black or grey markets, and will be widely proliferated. Further, because AM lends itself to precision manufacturing with lightweight materials, there may be financial, functional, or operational advantages for law enforcement or the Department of Defense to fabricate legitimate firearms using AM techniques.

### BRIEF SUMMARY

The present invention relates to additive manufacturing (or 3D printing). More particularly, the present invention relates to embedding chemical or physical markers (i.e., tags) in a host resin-based, polymer or thermoplastic matrix used as feedstock for AM. These tags can comprise detectable levels of magnetic, electromagnetic, ferromagnetic and other metal alloy materials within the metallic feedstock materials used to create objects via AM. Feedstock including tags can be used to manufacture firearms or other objects. The properties of such tags may be used to improve, enhance, or degrade-by-design the properties of the host material. Accordingly, the use of tags can provide traceability, authentication, and other characteristics to a firearm that enable detection and communication between the firearm and sensors.

The inclusion of tags within the feedstock can serve two primary objectives. First, by embedding sufficient concentrations of tags within a printed object, the object can be detected by an induction coil or electromagnetic concealed weapons detection scanner or wand. Second, by embedding sufficient concentrations of tags and/or orienting the tags within a printed object, the object can be uniquely identified using simple electrical test equipment.

In one embodiment, the present invention is implemented as a composition of matter comprising a feedstock material for use in additive manufacturing, and tags comprised of a conductive metallic material, the tags being embedded within the feedstock material during the additive manufacturing process.

In another embodiment, the present invention is implemented as a method for forming an object via an additive manufacturing process comprising printing the object from a feedstock material, the feedstock material comprising tags formed of a conductive metal material.

In another embodiment, the present invention is implemented as firearm printed via an additive manufacturing process, the firearm comprising a base material, and ferromagnetic tags embedded within the base material.

This summary is provided to introduce a selection of concepts in a simplified form that are further described below in the Detailed Description. This Summary is not intended to identify key features or essential features of the claimed subject matter.

### DETAILED DESCRIPTION

The present invention relates to additive manufacturing (or 3D printing). More particularly, the present invention relates to embedding chemical or physical markers (i.e., tags) in a host resin-based, polymer or thermoplastic matrix used as feedstock for AM. These tags cam comprise detectable levels of magnetic, electromagnetic, ferromagnetic and other metal alloy materials within the metallic feedstock materials used to create objects via AM. Feedstock including tags can be used to manufacture firearms or other objects. The properties of such tags may be used to improve, enhance, or degrade-by-design the properties of the host material. Accordingly, the use of tags can provide traceability, authentication, and other characteristics to a firearm that enable detection and communication between the firearm and sensors.

The inclusion of tags within the feedstock can serve two primary objectives. First, by embedding sufficient concentrations of tags within a printed object, the object can be detected by an induction coil or electromagnetic concealed weapons detection scanner or wand. Second, by embedding sufficient concentrations of tags and/or orienting the tags within a printed object, the object can be uniquely identified using simple electrical test equipment.

As an example, a component can be fabricated from a feedstock consisting of ABS, PVC or other plastic/thermoplastic material, or metal alloy of low electromagnetic strength, such as titanium, and tags comprised of a ferromagnetic material such as ferrite can be additively incorporated to the feedstock as a powdered particle or through a solvent. The inclusion of the ferromagnetic tags into the feedstock can cause an object formed with the feedstock to be detectable due to the magnetic properties of the added ferromagnetic tags.

Similarly, a barrel, lower receiver, or other mechanism needed to make the firearm operational could be manufactured additively in whole or as a system, not just in part; again yielding a complex part that is traceable and detectable.

In some embodiments, the position of tags within the printed object can be controlled during the printing process to form a network of magnetically and electrically conductive patterns unique to a particular component. In this way, the printed object can have an embedded identity that is detectable via simple electrical components. For example, tags could be positioned at a unique combination of locations within a printed firearm which unique combination could be later detected to uniquely identify the firearm. Similarly, unique concentrations of tags could be used to give the printed object a unique identity (e.g., a first concentration of tags in the tip of the barrel versus a second concentration of tags in the grip).

The positioning of tags within a printed object can be accomplished in various ways. For example, an inductive coil or other magnetic device could be used to attract tags to a particular location while the tags are capable of migrating within the feedstock (e.g., prior to curing of the feedstock). Alternatively, tags can be injected into the feedstock in a controlled manner (e.g., at specific times) so that a desired concentration of tags exists in the feedstock used to print a particular location of a part.

By embedding tags into the feedstock (whether plastic or metal), the printed parts will become more easily detectable. For example, for a handgun that is printed from titanium feedstock, the barrel is often the only part that has sufficient iron content to generate a dipole moment for the electromagnetic coil of the magnetometer to propagate a signal. Often successful detection of such handguns is dependent on the relative orientations of the electromagnetic field generated by the sensor and the barrel. This would also be the case for handguns printed from phenolic or resin, low iron alloy metals, or metals similar to titanium (which typically employ a barrel liner formed of iron to give the barrel sufficient strength to survive the stresses of a high-pressure discharge). The present invention can ensure that a handgun will be detectable by distributing sufficient quantities (i.e., mass) of ferromagnetic tags into the feedstock.

Embodiments of the present invention may also be directed to incorporating a microchip, sensor, or other wired or wireless networked device capable of emitting and receiving signals (collectively, “chip”) into a printed object that contains tags. When a remote signal is sent to the chip, the chip emits an electrical discharge, vibration, sound or other signal that changes the chemical and physical properties of the tags contained within the printed object. This change in the chemical and physical properties of the tags will in turn cause the characteristics of the feedstock to be altered such as by altering a firearm's strength, flexibility, thermal characteristics, or other characteristics. One benefit of employing a chip with a firearm is that the firearm could be enabled/disabled by a third party.

In some embodiments, the tags themselves may react directly to the firing of a firearm to cause a change in their characteristics. In such cases, a chip may not need to be incorporated into the firearm. For example, the tags embedded within a firearm may be configured to respond to the vibration and sound caused when the firearm is fired thereby causing piezoelectric stress on the tags. This stress can cause the feedstock material to harden or soften in such a way that can alter the firearm's usefulness and functionality. Similarly, the concentration, mass and location of tags within a printed firearm can be controlled (as described above) so that a particular portion of the firearm (e.g., a trigger) will degrade over time.

Tags suitable for use in the present invention can be formed of one or more of the following materials: Ferrite, Alnico, Bismanol, Cunife, Fernico Alloys, Intermetalics such as Heusler Alloy, Nickel, Nickel Cobalt Alloy, Metglas, Mictomagnetic Alloy, MKM Steel, Neodymium, Permalloy, Samarium, Sendust, Supermalloy, Iron-Neodymium-Boron, Aluminum-Nickel-Cobalt, Samarium-Cobalt, Neodymium, Iron and Boron Nd2Fe14B, Radioactive candidate additives including gadolinium (Gd), Radioactive actinide curium (Cm), Alkaline-earth cerates and zirconate based perovskite materials including Acceptor doped SrCe03, BaCeO3 and BaZrO3, and Multiferroics.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed:

1. A composition of matter comprising:
a feedstock material for use in additive manufacturing; and
tags comprised of a conductive metallic material, the tags being embedded within the feedstock material during the additive manufacturing process.

2. The composition of matter of claim 1, wherein the tags are comprised of ferrite.

3. The composition of matter of claim 1, wherein the tags are comprised of an iron alloy.

4. The composition of matter of claim 1, wherein the feedstock material is a plastic.

5. The composition of matter of claim 1, wherein the feedstock material comprises a non-conductive metal.

6. A method for forming an object via an additive manufacturing process, the method comprising:
printing the object from a feedstock material, the feedstock material comprising tags formed of a conductive metal material.

7. The method of claim 6, wherein the tags comprise a metallic material, the method further comprising:
positioning a magnetic component near the object while the object is being printed to attract the tags to a particular position within the object.

8. The method of claim 7, wherein the tags are attracted to a plurality of positions which uniquely identify the object.

9. The method of claim 6, wherein the object is a firearm or a component of a firearm.

10. The method of claim 6, further comprising:
controlling the distribution of the tags within the feedstock material.

11. The method of claim 10, wherein the tags are distributed into a pattern that uniquely identifies the object.

12. The method of claim 10, wherein the tags are distributed into a concentration that uniquely identifies the object.

13. The method of claim 10, wherein the tags are distributed into a unique combination of locations within the object.

14. The method of claim 10, wherein the tags are distributed in a concentration that causes the object to be detectable by a magnetic sensor.

15. The method of claim 10, wherein controlling the distribution of the tags comprises controlling an orientation of the tags within the object.

16. The method of claim 6, further comprising:
using a sensor to detect the tags within the object.

17. The method of claim 6, further comprising:
using a sensor to identify one or more locations of the tags within the object.

18. A firearm printed via an additive manufacturing process, the firearm comprising:
a base material; and
ferromagnetic tags embedded within the base material.

19. The firearm of claim 18, wherein the base material is plastic.

20. The firearm of claim 18, further comprising:
a barrel liner formed of a ferromagnetic material.

21. A component of a firearm printed via an additive manufacturing process comprising:
a base material; and
ferromagnetic tags embedded within the base material.

22. The component of the firearm of claim 21, wherein the base material is plastic.

23. The component of the firearm of claim 21, further comprising:
a barrel liner formed of a ferromagnetic material.

24. The component of the firearm of claim 21, wherein the component is a lower receiver.
